(19) United States
(12) Patent Application Publication
(10) Pub. No.: US 2011/0143216 A1
(43) Pub. Date: Jun. 16, 2011

(54) LITHIUM SECONDARY BATTERY

(75) Inventors: Toshikazu Yoshida, Kobe-shi (JP); Hidekazu Yamamoto, Kobe-shi (JP)

(73) Assignee: SANYO ELECTRIC CO., LTD., Osaka (JP)

(21) Appl. No.: 12/961,863

(22) Filed: Dec. 7, 2010

(30) Foreign Application Priority Data
Dec. 11, 2009 (JP) 2009-281407
Sep. 1, 2010 (JP) 2010-195467

(51) Int. Cl. H01M 10/056

(52) U.S. Cl. 429/325; 429/338; 429/331

(57) ABSTRACT

A lithium secondary battery includes a positive electrode containing a lithium transition-metal oxyanion compound as a positive electrode active material, a negative electrode containing amorphous carbon-coated graphite as a negative electrode active material, and a non-aqueous electrolyte solution, wherein the non-aqueous electrolyte solution contains vinylene carbonate and a solvent and/or a solute that decomposes at a potential more electropositive than that of vinylene carbonate.

### CROSS REFERENCE TO RELATED APPLICATIONS

The present invention contains subject matter related to Japanese Patent Application No. 2010-195467 filed in the Japan Patent Office on Sep. 1, 2010, the entire contents of which are incorporated herein by reference.

### BACKGROUND OF THE INVENTION

1. Field of the Invention

The present invention relates to a lithium secondary battery in which a lithium transition-metal oxyanion compound such as LiFePO₄ is used as a positive electrode active material.

2. Description of Related Art

In non-aqueous electrolyte secondary batteries, currently, LiCoO₂ is used as a positive electrode; lithium metal, a lithium alloy, or a carbon material that can occlude and release lithium is used as a negative electrode; and a solution prepared by dissolving an electrolyte composed of a lithium salt such as LiBF₄ or LiPF₆ in an organic solvent such as ethylene carbonate or diethyl carbonate is used as a non-aqueous electrolyte solution.

However, when LiCoO₂ is used as the positive electrode, the production cost increases because cobalt (C0) reserves are limited, that is, cobalt is a rare resource and is expensive. Furthermore, in such a battery including LiCoO₂, the thermal stability of the battery at high temperature in a charging state is significantly lower than that in a state of normal use. Therefore, the use of LiMn₂O₄ as an alternative positive electrode material replacing LiCoO₂ has been studied. However, the use of LiMn₂O₄ has problems that a sufficient discharge capacity cannot be realized, and that manganese is dissolved at high battery temperatures.

Consequently, olivine-type lithium phosphates such as LiFePO₄ have attracted attention as a positive electrode material replacing LiCoO₂. Olivine-type lithium phosphates are lithium complex compounds represented by the general formula LiMPO₄ (where M is at least one element selected from Co, Ni, Mn, and Fe), and the operating voltage varies depending on the type of metal element M serving as a core. In addition, any battery voltage can be selected by appropriately selecting M, and the theoretical capacity is also relatively high, namely, about 140 to 170 mAh/g. Thus, the use of such olivine-type lithium phosphates is advantageous in that the battery capacity per unit mass can be increased. Furthermore, iron (Fe) can be selected as M in the general formula. Since iron is produced in large amounts and is inexpensive, olivine-type lithium phosphates are advantageous in that the production cost can be markedly reduced by using iron, and are suitable for a positive electrode material of large batteries and high-output batteries.

Japanese Published Unexamined Patent Application No. 2004-273424 (Patent Document 1) has proposed that good output characteristics can be achieved by using amorphous carbon-coated graphite as a negative electrode material.

Japanese Published Unexamined Patent Application No. 2008-269980 (Patent Document 2) has proposed that good safety and rate characteristics after storage can be achieved by decreasing the viscosity of an electrolyte solution containing sulfolane and forming a film on an electrode.

Japanese Published Unexamined Patent Application No. 2009-4357 (Patent Document 3) has proposed that good high-temperature cycle characteristics and output characteristics can be achieved by suppressing elution of iron (Fe) and the influence of eluted iron (Fe) on the negative electrode. Japanese Published Unexamined Patent Application No. 2009-48981 (Patent Document 4) has proposed that cycle characteristics are improved by suppressing the generation of hydrogen fluoride (HF) by incorporating fluoroethylene carbonate.

Japanese Published Unexamined Patent Application No. 2008-91236 (Patent Document 5) discloses a lithium secondary battery in which low crystalline carbon-coated graphite coated with a low crystalline carbon material is used as a negative electrode active material and vinylene carbonate is contained in a non-aqueous electrolyte solution. However, Patent Document 5 does not mention the effect of the addition of vinylene carbonate when a lithium transition-metal oxyanion compound is used as a positive electrode active material. In Japanese Published Unexamined Patent Application No. 2009-87934 (Patent Document 6), in a secondary battery including a negative electrode active material containing silicon (Si) or the like, cycle characteristics can be improved by incorporating an aromatic isocyanate compound in an electrolyte solution.

### BRIEF SUMMARY OF THE INVENTION

Patent Document 1 describes that output characteristics can be improved by using amorphous carbon-coated graphite. However, Patent Document 1 does not mention the influence on the storage characteristics when a lithium transition-metal oxyanion compound such as LiFePO₄ is used as a positive electrode active material.

Patent Document 2 discloses that both safety and rate characteristics can be combined by incorporating sulfolane in an electrolyte solution. However, Patent Document 2 does not describe improvements in the degradation of storage characteristics and low-temperature output characteristics due to the use of vinylene carbonate.

Patent Document 3 describes that elution of iron and the influence of eluted iron on the negative electrode are suppressed by using vinylene carbonate. However, Patent Document 3 does not mention the influence on the output characteristics and storage characteristics of the negative electrode.

Patent Document 4 describes that, in a lithium secondary battery in which LiFePO₄ is used as a positive electrode active material, the generation of hydrogen fluoride (HF) or the like is suppressed by incorporating fluorinated ethylene carbonate (FEC) in a non-aqueous electrolyte solution, thus improving lifetime characteristics. However, Patent Document 4 discloses no method for improving storage characteristics and low-temperature output characteristics.

Patent Document 6 describes that cycle characteristics of a secondary battery including a negative electrode active material containing Si or the like can be improved by incorporating an aromatic isocyanate compound in an electrolyte solution. However, Patent Document 6 does not mention the influence on the output and storage characteristics when a lithium transition-metal oxyanion compound is used as a positive electrode active material and amorphous carbon-coated graphite is used as a negative electrode active material.

None of Patent Documents 1 to 6 discloses a specific method that can improve storage characteristics and low-temperature output characteristics in a lithium secondary battery including a lithium transition-metal oxyanion compound, such as LiFePO₄, as a positive electrode active material.

It is desirable to provide a lithium secondary battery including a lithium transition-metal oxyanion compound, such as LiFePO₄, as a positive electrode active material and having improved storage characteristics and low-temperature output characteristics.

An aspect of the present invention provides a lithium secondary battery including a positive electrode containing a lithium transition-metal oxyanion compound as a positive electrode active material; a negative electrode containing amorphous carbon-coated graphite as a negative electrode active material; and a non-aqueous electrolyte solution, in which the non-aqueous electrolyte solution contains vinylene carbonate and a solvent and/or a solute that decomposes at a potential more electropositive than that of vinylene carbonate.

According to this aspect of the present invention, storage characteristics and low-temperature output characteristics can be improved. According to the aspect of the present invention, vinylene carbonate and a solvent and/or a solute that decomposes at a potential more electropositive than that of vinylene carbonate are contained in the non-aqueous electrolyte solution. It is believed that, consequently, in initial charge and discharge, the solvent and/or the solute that decomposes at a potential more electropositive than that of vinylene carbonate decomposes prior to the decomposition of vinylene carbonate, and forms a stable film on the surface of the negative electrode. Furthermore, vinylene carbonate then decomposes, thereby forming a stable film on the surface of the positive electrode, thus preventing an element such as Fe from eluting from the positive electrode active material to the non-aqueous electrolyte solution. Consequently, according to this aspect of the present invention, the storage characteristics and the low-temperature output characteristics can be improved.

Examples of the lithium transition-metal oxyanion compound used as the positive electrode active material in the aspect of the present invention include lithium complex compounds which are represented by the general formula LiMPO₄ (where M is at least one element selected from Co, Ni, Mn, and Fe), such as olivine-type lithium iron phosphate. As for M, iron (Fe) is preferably contained as a main component. Accordingly, lithium transition-metal oxyanion compounds containing iron as the transition metal are preferred. In addition, a part of M may be replaced with Mn, Co, Ni or the like. An example of the typical compound is LiFePO₄ or LiMPO₄ in which most of M is Fe.

In the aspect of the present invention, the amorphous carbon-coated graphite used as the negative electrode active material is graphite coated with amorphous carbon. In the amorphous carbon-coated graphite, the entire surface of graphite need not be coated with amorphous carbon, and a part of graphite may be exposed to the surface. The amorphous carbon-coated graphite can be produced by the method disclosed in Patent Document 1, for example.

The content of the amorphous carbon in the amorphous carbon-coated graphite is preferably in the range of 0.1 to 10 mass percent. When the content of the amorphous carbon in the amorphous carbon-coated graphite is less than 0.1 mass percent, sufficient output characteristics may not be obtained. When the content of the amorphous carbon in the amorphous carbon-coated graphite exceeds 10 mass percent, sufficient storage characteristics may not be obtained.

The content of the vinylene carbonate in the non-aqueous electrolyte solution is preferably in the range of 0.1 to 5 mass percent. When the content of the vinylene carbonate in the non-aqueous electrolyte solution is less than 0.1 mass percent, a sufficient film may not be formed on the positive electrode. When the content of the vinylene carbonate in the non-aqueous electrolyte solution exceeds 5 mass percent, a film originated in vinylene carbonate is also formed on the surface of the negative electrode. As a result, the interface resistance of the negative electrode increases, and charge-discharge characteristics may decrease.

Examples of the solvent that decomposes at a potential more electropositive than that of vinylene carbonate include, fluoroethylene carbonate, vinyl ethylene carbonate, and 1,6-diisocyanate hexane. As for isocyanate compounds, linear isocyanate compounds are preferably used rather than aromatic isocyanate compounds. Aromatic isocyanate compounds are not preferable because they tend to exhibit an electron-withdrawing property due to the effect of resonance, and thus an isocyanate group bonded to an aromatic ring is active with a high possibility, and the resistance increases in the formation of the film on the negative electrode. Specific examples of the linear isocyanate compounds include 1,4-diisocyanate hexane, 1,8-diisocyanate hexane, and 1,12-diisocyanate hexane besides 1,6-diisocyanate hexane.

The content of the solvent that decomposes at an electropositive potential, such as fluoroethylene carbonate, vinyl ethylene carbonate, or 1,6-diisocyanate hexane, in the non-aqueous electrolyte solution is preferably in the range of 0.1 to 10 mass percent. When the content of the solvent is less than 0.1 mass percent, a sufficient film may not be formed on the negative electrode. When the content of the solvent exceeds 10 mass percent, the interface resistance of the negative electrode increases, and charge-discharge characteristics may decrease.

An example of the solute that decomposes at a potential more electropositive than that of vinylene carbonate is Li[B(C₂O₄)₂]. The concentration of the solute that decomposes at a electropositive potential, such as Li[B(C₂O₄)₂], in the non-aqueous electrolyte solution is preferably in the range of 0.05 to 0.3 M (mol/L). When the concentration of the solute is less than 0.05 M, a sufficient film may not be formed on the negative electrode. When the concentration of the solute exceeds 0.3 M, the interface resistance of the negative electrode increases, and charge-discharge characteristics may decrease.

Whether or not a solvent or a solute decomposes at a potential more electropositive than that of vinylene carbonate can be determined by preparing a three-electrode cell including a reference electrode and a counter electrode each composed of lithium metal, a working electrode composed of amorphous carbon-coated graphite, and a non-aqueous electrolyte solution containing a target solvent or solute, and measuring a cyclic voltammogram, as described below.

Examples of other solvents used as the non-aqueous electrolyte solution include mixed solvents of a cyclic carbonate such as ethylene carbonate, propylene carbonate, or butylene carbonate and a chain carbonate such as dimethyl carbonate, methyl ethyl carbonate, or diethyl carbonate; and mixed solvents of such a cyclic carbonate and an ether such as 1,2-dimethoxyethane or 1,2-diethoxyethane.

Examples of other solutes contained in the non-aqueous electrolyte solution include LiXFₚ (where X represents P, As, Sb, Al, B, Bi, Ga, or In, when X is P, As, or Sb, p is 6, and when X is Al, B, Bi, Ga, or In, p is 4), LiN(CₘF₂ₘ₊₁SO₂)(CₙF₂ₙ₊₁SO₂) (where m=1, 2, 3, or 4, and n=1, 2, 3, or 4), LiC(C₁F₂₁₊₁SO₂)(CₘF₂ₘ₊₁SO₂)(CₙF₂ₙ₊₁SO₂) (where 1=1, 2, 3, or 4μm=1, 2, 3, or 4, and n=1, 2, 3, or 4), Li[M(C₂O₄)ₓR_{y}] (where M represents a transition metal or an element selected from group IIIb, group IVb, and group Vb in the periodic table, R represents a group selected from a halogen, an alkyl group, and a halogenated alkyl group, x represents a positive integer, and y represents 0 or a positive integer), and mixtures thereof.

The concentration of LiXFₚ (where X represents P, As, Sb, Al, B, Bi, Ga, or In, when X is P, As, or Sb, p is 6, and when X is Al, B, Bi, Ga, or In, p is 4) is preferably as high as possible as long as the solute is dissolved without precipitation.

According to the aspect of the present invention, in a lithium secondary battery including, as a positive electrode active material, a lithium transition-metal oxyanion compound, such as LiFePO₄, storage characteristics and low-temperature output characteristics can be improved.

### BRIEF DESCRIPTION OF THE SEVERAL VIEWS OF THE DRAWINGS

FIG. 1 is a schematic cross-sectional view showing a lithium secondary battery fabricated in examples according to the present invention;

FIG. 2 is a schematic cross-sectional view of a three-electrode cell used for measuring a cyclic voltammogram;

FIG. 3 is a cyclic voltammogram of a non-aqueous electrolyte solution containing vinylene carbonate; and

FIG. 4 is a cyclic voltammogram of a non-aqueous electrolyte solution containing vinylene carbonate and Li[B(C₂O₄)₂].

### DETAILED DESCRIPTION OF THE INVENTION

The present invention will now be more specifically described using examples. The present invention is not limited to the examples described below and can be implemented with modifications without departing from the spirit of the present invention.

### Example 1

### Preparation of Positive Electrode Active Material

First, FeSO₄.7H₂O, H₃PO₄ (82.6 mass percent), and LiOH were weighed so that the ratio FeSO₄.7H₂O:H₃PO₄:LiOH was 1:1:3.1 by mole. The weighed FeSO₄.7H₂O and water were weighed so that the ratio FeSO₄.7H₂O:water was 1:2 by mass, and FeSO₄.7H₂O was then dissolved in water. Furthermore, H₃PO₄ was dissolved in the resulting aqueous solution. The weighed LiOH and water were weighed so that the ratio LiOH:water was 1:10 by mass, and then mixed. This aqueous LiOH solution was gradually added to the above-prepared aqueous solution while stirring with a stirrer. Subsequently, hydrothermal synthesis was conducted in an autoclave at 160° C. for five hours to obtain LiFePO₄.

Subsequently, the LiFePO₄ prepared above, sucrose, and water were weighed so that the ratio LiFePO₄:sucrose:water was 20:6:8 by weight and processed with a ball mill at 100 rpm for 18 minutes. Subsequently, the resulting mixture was dried at 50° C. in order to remove moisture, and heat-treated in a vacuum at 850° C. for five hours. The resulting powder had an average particle diameter of 0.7 μm and a BET specific surface area of 14 m²/g. Note that sucrose was added in order to coat the surface of LiFePO₄ with carbon.

### Preparation of Positive Electrode

The LiFePO₄ obtained above was used as a positive electrode active material. The LiFePO₄, acetylene black serving as an electrically conductive agent, and polyvinylidene fluoride serving as a binder were mixed so that the ratio LiFePO₄:acetylene black:polyvinylidene fluoride was 90:5:5 by weight, and an appropriate amount of N-methyl-2-pyrrolidone (NMP) was then added to the resulting mixture to prepare a slurry.

The slurry was applied onto an aluminum foil by a doctor blade method and was then dried. The resulting aluminum foil was cut to have a size of 55 mm×750 mm, and rolled with a roller. A positive electrode lead was attached to the aluminum foil, and the resulting aluminum foil was used as a positive electrode.

### Preparation of Negative Electrode

Amorphous carbon-coated natural graphite (amorphous carbon content: 2 mass percent) was used as a negative electrode active material. The amorphous carbon-coated natural graphite and a polyvinylidene fluoride powder serving as a binder were mixed so that the ratio amorphous carbon-coated natural graphite:polyvinylidene fluoride was 98:2 by weight. An appropriate amount of NMP was then added to the resulting mixture to prepare a slurry.

The slurry was applied onto a copper foil by a doctor blade method and was then dried. The resulting copper foil was cut to have a size of 58 mm×850 mm, and rolled with a roller. A negative electrode lead was attached to the copper foil, and the resulting copper foil was used as a negative electrode.

### Preparation of Non-Aqueous Electrolyte Solution

Ethylene carbonate and methyl ethyl carbonate were mixed so that the ratio ethylene carbonate:methyl ethyl carbonate was 3:7 by volume to prepare a mixed solvent. Next, LiPF₆ was dissolved in the mixed solvent so as to have a concentration of 1 mole/L. Subsequently, vinylene carbonate and fluoroethylene carbonate were mixed thereto so that the resulting solution contained 1 mass percent of vinylene carbonate and 1 mass percent of fluoroethylene carbonate. Thus, a non-aqueous electrolyte solution was prepared.

### Fabrication of Lithium Secondary Battery

A 18650-type lithium secondary battery was fabricated by using the above positive electrode, the negative electrode, the non-aqueous electrolyte solution, and a separator composed of a polyethylene microporous film.

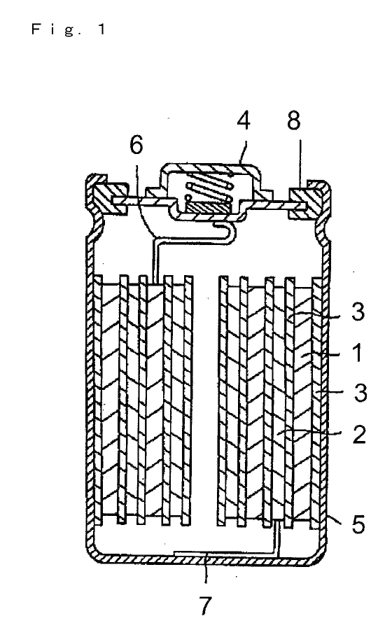

FIG. 1 is a schematic cross-sectional view showing the prepared lithium secondary battery. The lithium secondary battery shown in FIG. 1 includes a positive electrode 1, a negative electrode 2, a separator 3, a sealing member 4 that also functions as a positive electrode terminal, a negative electrode can 5, a positive electrode current collector 6, a negative electrode current collector 7, an insulting gasket 8 etc. The positive electrode 1 and the negative electrode 2 face each other, with the separator 3 therebetween, and are accommodated in a battery can composed of the sealing member 4 and the negative electrode can 5. The positive electrode 1 is connected to the sealing member 4 that also functions as the positive electrode terminal, with the positive electrode current collector 6 therebetween, and the negative electrode 2 is connected to the negative electrode can 5, with the negative electrode current collector 7 therebetween, so that chemical energy generated inside the battery can be output as electrical energy.

### Example 2

A lithium secondary battery was fabricated as in EXAMPLE 1 except that vinyl ethylene carbonate was used instead of fluoroethylene carbonate.

### Example 3

A lithium secondary battery was fabricated as in EXAMPLE 1 except that 0.1 M of Li[B(C₂O₄)₂] was used instead of 1 mass percent of fluoroethylene carbonate.

### Example 4

A lithium secondary battery was fabricated as in EXAMPLE 1 except that 0.2 M of Li[B(C₂O₄)₂] was used instead of 1 mass percent of fluoroethylene carbonate.

### Example 5

A lithium secondary battery was fabricated as in EXAMPLE 1 except that the amount of fluoroethylene carbonate was changed from 1 mass percent to 2 mass percent.

### Example 6

A lithium secondary battery was fabricated as in EXAMPLE 1 except that the amount of fluoroethylene carbonate was changed from 1 mass percent to 4 mass percent.

### Example 7

A lithium secondary battery was fabricated as in EXAMPLE 1 except that the amount of fluoroethylene carbonate was changed from 1 mass percent to 9 mass percent.

### Example 8

A lithium secondary battery was fabricated as in EXAMPLE 1 except that 2 mass percent of vinyl ethylene carbonate was used instead of 1 mass percent of fluoroethylene carbonate.

### Example 9

A lithium secondary battery was fabricated as in EXAMPLE 1 except that 0.5 mass percent of 1,6-diisocyanate hexane was used instead of 1 mass percent of fluoroethylene carbonate.

### Example 10

A lithium secondary battery was fabricated as in EXAMPLE 1 except that 1 mass percent of 1,6-diisocyanate hexane was used instead of 1 mass percent of fluoroethylene carbonate.

### Comparative Example 1

A lithium secondary battery was fabricated as in EXAMPLE 1 except that natural graphite was used as the negative electrode active material, and that, in the preparation of the electrolyte solution, 2 mass percent of only vinylene carbonate was mixed in the electrolyte solution without mixing fluoroethylene carbonate.

### Comparative Example 2

A lithium secondary battery was fabricated as in EXAMPLE 1 except that, in the preparation of the electrolyte solution, 1 mass percent of only vinylene carbonate was mixed in the electrolyte solution without mixing fluoroethylene carbonate.

### Comparative Example 3

A lithium secondary battery was fabricated as in EXAMPLE 1 except that, in the preparation of the electrolyte solution, 2 mass percent of only vinylene carbonate was mixed in the electrolyte solution without mixing fluoroethylene carbonate.

### Comparative Example 4

A lithium secondary battery was fabricated as in EXAMPLE 1 except that, in the preparation of the electrolyte solution, 2 mass percent of only fluoroethylene carbonate was mixed in the electrolyte solution without mixing vinylene carbonate.

### Comparative Example 5

A lithium secondary battery was fabricated as in COMPARATIVE EXAMPLE 2 except that LiNi_{0.33}CO_{0.33}Mn_{0.33}O₂ was used as the positive electrode active material.

### Comparative Example 6

A lithium secondary battery was fabricated as in EXAMPLE 3 except that LiNi_{0.33}CO_{0.33}Mn_{0.33}O₂ was used as the positive electrode active material.

### Charge-Discharge Test

The batteries fabricated as described above were each charged at 25° C. at 1,000 mA to 200 mAh, and then left to stand at 60° C. for one day. The change in the voltage after standing was determined using the formula below.

Change in voltage (V)=Voltage after standing (V)−Voltage before standing (V)

The change in the voltage which is determined as described above and is an index of storage characteristics is shown in Table 1.

Furthermore, the batteries after standing were each charged at 25° C. at 1,000 mA up to 4.2 V at a constant current, and then charged up to 50 mA at a constant voltage. Subsequently, the batteries were each discharged at 1,000 mA down to 2.0 V, thus performing one cycle of charge-discharge. The efficiency was determined using the formula below.

Efficiency (%)=Discharge capacity/(Charge capacity before standing+Charge capacity after standing)

Subsequently, the batteries were each charged at 1,000 mA to 500 mAh. The batteries were then discharged at −20° C. at a constant current, and the current value at which the voltage after 10 seconds becomes 2.2 V was measured. The output was determined using the formula below.

Output (W)=Current value (A) at which the voltage after 10 seconds of discharge at a constant current becomes 2.2 V×2.2 (V)

Furthermore, an output ratio (%) was determined using the formula below under the assumption that the value of the output of EXAMPLE 1 is 100.

Output ratio (%)=Output (W)/Output (W) of EXAMPLE 1

The output ratio (%) which is an index of low-temperature output characteristics is shown in Table 1.

TABLE 1

| | | | | | Effi- | Output |
|---|---|---|---|---|---|---|
| | | | | Change in | ciency | ratio |
| | Positive electrode | Negative electrode | Electrolyte solution | voltage (V) | (%) | (%) |
| Example 1 | LiFePO₄ | Amorphous carbon-coated natural graphite | Vinylene carbonate 1% + | −0.216 | 80 | 100 |
| | | | Fluoroethylene carbonate 1% | | | |
| Example 2 | LiFePO₄ | Amorphous carbon-coated natural graphite | Vinylene carbonate 1% + | −0.199 | 81 | 83 |
| | | | Vinyl ethylene carbonate 1% | | | |
| Example 3 | LiFePO₄ | Amorphous carbon-coated natural graphite | Vinylene carbonate 1% + | −0.231 | 79 | 91 |
| | | | 0.1M Li[B(C₂O₄)₂] | | | |
| Example 4 | LiFePO₄ | Amorphous carbon-coated natural graphite | Vinylene carbonate 1% + | −0.198 | 78 | 80 |
| | | | 0.2M Li[B(C₂O₄)₂] | | | |
| Example 5 | LiFePO₄ | Amorphous carbon-coated natural graphite | Vinylene carbonate 1% + | −0.053 | 81 | 90 |
| | | | Fluoroethylene carbonate 2% | | | |
| Example 6 | LiFePO₄ | Amorphous carbon-coated natural graphite | Vinylene carbonate 1% + | −0.049 | 80 | 83 |
| | | | Fluoroethylene carbonate 4% | | | |
| Example 7 | LiFePO₄ | Amorphous carbon-coated natural graphite | Vinylene carbonate 1% + | −0.047 | 78 | 80 |
| | | | Fluoroethylene carbonate 9% | | | |
| Example 8 | LiFePO₄ | Amorphous carbon-coated natural graphite | Vinylene carbonate 1% + | −0.040 | 80 | 81 |
| | | | Vinyl ethylene carbonate 2% | | | |
| Example 9 | LiFePO₄ | Amorphous carbon-coated natural graphite | Vinylene carbonate 1% + | −0.088 | 80 | 88 |
| | | | 1,6-Diisocyanate hexane 0.5% | | | |
| Example 10 | LiFePO₄ | Amorphous carbon-coated natural graphite | Vinylene carbonate 1% + | −0.051 | 83 | 81 |
| | | | 1,6-Diisocyanate hexane 1% | | | |
| Comparative | LiFePO₄ | Natural graphite | Vinylene carbonate 2% | −0.143 | 84 | 18 |
| Example 1 | | | | | | |
| Comparative | LiFePO₄ | Amorphous carbon-coated natural graphite | Vinylene carbonate 1% | −0.381 | 65 | 51 |
| Example 2 | | | | | | |
| Comparative | LiFePO₄ | Amorphous carbon-coated natural graphite | Vinylene carbonate 2% | −0.270 | 79 | 68 |
| Example 3 | | | | | | |
| Comparative | LiFePO₄ | Amorphous carbon-coated natural graphite | Fluoroethylene carbonate 2% | −0.320 | 72 | 70 |
| Example 4 | | | | | | |
| Comparative | LiNi_{0.33}Co_{0.33}Mn_{0.33}O₂ | Amorphous carbon-coated natural graphite | Vinylene carbonate 1% | −0.255 | 76 | 77 |
| Example 5 | | | | | | |
| Comparative | LiNi_{0.33}Co_{0.33}Mn_{0.33}O₂ | Amorphous carbon-coated natural graphite | Vinylene carbonate 1% + | −0.246 | 75 | 75 |
| Example 6 | | | 0.1M Li[B(C₂O₄)₂] | | | |

As is apparent from the comparison among EXAMPLES 1 to 10 and COMPARATIVE EXAMPLES 2 to 4, in accordance with the present invention, by incorporating vinylene carbonate and fluoroethylene carbonate, vinyl ethylene carbonate, 1,6-diisocyanate hexane, or Li[B(C₂O₄)₂], which decomposes at a potential more electropositive than that of vinylene carbonate, in the non-aqueous electrolyte solution, the change in the voltage reduced, the storage characteristics improved, and the output ratio also increased, thus improving the low-temperature output characteristics.

Referring to EXAMPLE 1 and EXAMPLES 5 to 7, when the amount of fluoroethylene carbonate was increased, the absolute value of the change in the voltage decreased to improve the storage characteristics, whereas the output ratio decreased, thus decreasing the low-temperature output characteristics.

Referring to EXAMPLES 9 and 10, the use of 1,6-diisocyanate hexane particularly improved the storage characteristics and the efficiency.

As is apparent from COMPARATIVE EXAMPLE 1, in the case where amorphous carbon-coated natural graphite was not used as the negative electrode active material, the low-temperature output characteristics further decreased.

As is apparent from the comparison between COMPARATIVE EXAMPLE 5 and COMPARATIVE EXAMPLE 6, and the comparison between COMPARATIVE EXAMPLE 2 and EXAMPLE 3, in the cases where a lithium transition-metal oxyanion compound was not used as the positive electrode active material, improvements in the storage characteristics and the low-temperature output characteristics, which are advantages of the present invention, were not observed. The reason for this is believed to be as follows. The positive electrode used in COMPARATIVE EXAMPLE 5 and COMPARATIVE EXAMPLE 6 contains a lithium transition-metal oxide, and thus, unlike LiFePO₄, a metal such as Fe does not elute from the positive electrode active material into the electrolyte solution. Therefore, the advantage that a film originated in vinylene carbonate is formed on the surface of the positive electrode to suppress the elution of the metal such as Fe is not observed.

In COMPARATIVE EXAMPLES 5 and 6, the positive electrode active material disclosed in Patent Document 5 is used. Thus, it is clear that the advantages of the present invention are not achieved in Patent Document 5.

Measurement of decomposition potentials of vinylene carbonate and Li[B(C₂O₄)₂].

### Preparation of Three-Electrode Cell

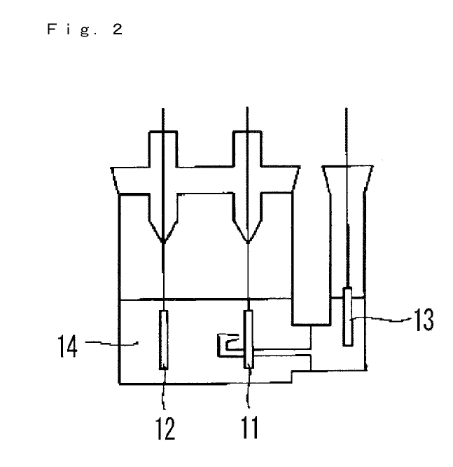

A three-electrode cell shown in FIG. 2 was fabricated. The amorphous carbon-coated natural graphite used in the above examples was used as a working electrode 11, and lithium metal was used as a counter electrode 12 and a reference electrode 13. The electrolyte solution used in COMPARATIVE EXAMPLE 2 and the electrolyte solution used in EXAMPLE 3 were each used as a non-aqueous electrolyte solution 14.

A cyclic voltammogram was measured under the conditions described below using the three-electrode cell fabricated as described above. Sweeping was started from an open circuit voltage (OCV) to the reduction side. The measurement was conducted at a potential scanning rate of 1 mV/sec in a potential range of 0 to 3.0 V vs. Li/Li⁺.

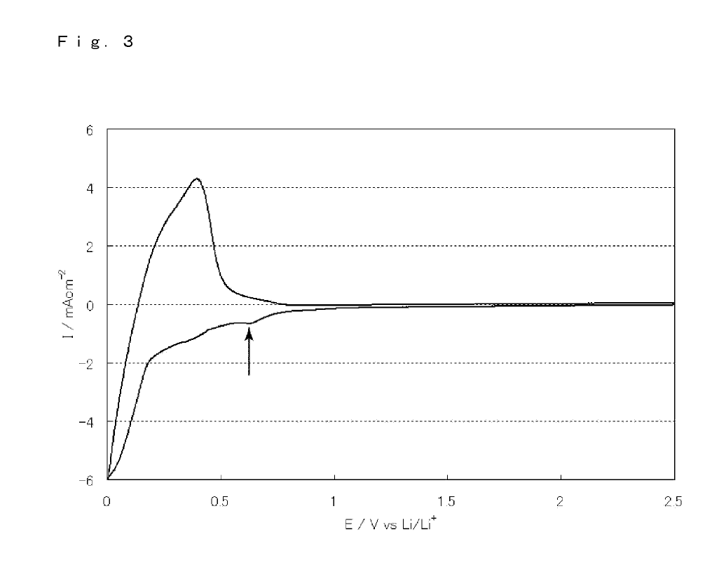

FIG. 3 shows a cyclic voltammogram of the electrolyte solution of COMPARATIVE EXAMPLE 2. Specifically, FIG. 3 shows a cyclic voltammogram of the electrolyte solution prepared by dissolving LiPF₆ in a mixed solvent containing ethylene carbonate and methyl ethyl carbonate at a volume ratio of 3:7, and then mixing 1 mass percent of only vinylene carbonate.

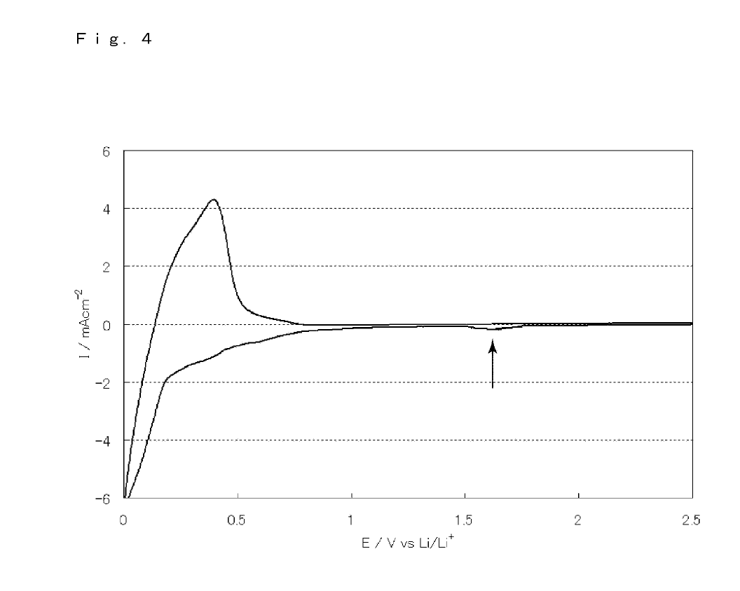

FIG. 4 shows a cyclic voltammogram of the electrolyte solution of EXAMPLE 3. Specifically, FIG. 4 shows a cyclic voltammogram of the electrolyte solution prepared by dissolving LiPF₆ in a mixed solvent containing ethylene carbonate and methyl ethyl carbonate at a volume ratio of 3:7, and then mixing 1 mass percent of vinylene carbonate and 0.1 mol/L of Li[B(C₂O₄)₂].

As is apparent from FIG. 3, in the electrolyte solution of COMPARATIVE EXAMPLE 2 containing only vinylene carbonate, a reduction current was observed at a potential of about 0.7 V vs. Li/Li⁺, as shown by the arrow in FIG. 3. Thus, it is found that vinylene carbonate is decomposed at this potential.

As shown in FIG. 4, in the case where vinylene carbonate and Li[B(C₂O₄)₂] were mixed, a reduction current was observed at a potential of about 1.6 V vs. Li/Li⁺, as shown by the arrow in FIG. 4. It is believed that this is because decomposition of Li[B(C₂O₄)₂] occurred before the decomposition of vinylene carbonate. Accordingly, it is believed that Li[B(C₂O₄)₂] is decomposed at this potential.

From the above results, it is believed that the following phenomenon occurs: By incorporating a solvent and/or a solute that decomposes at a potential more electropositive than that of vinylene carbonate in a non-aqueous electrolyte solution, the solvent and/or the solute decomposes prior to the decomposition of vinylene carbonate, thus forming a stable film on the negative electrode, whereas vinylene carbonate acts on the positive electrode to suppress the elution of a metal such as Fe from the positive electrode active material.

According to the results measured by the same method as that described above, the decomposition potential of vinyl ethylene carbonate was about 1.1 V vs. Li/Li⁺, the decomposition potential of fluoroethylene carbonate was about 0.9 V vs. Li/Li⁺, and the decomposition potential of 1,6-diisocyanate hexane was about 0.9 V vs. Li/Li⁺. Measurement of the amount of Fe eluted from positive electrode to negative electrode

The batteries of EXAMPLE 3 and COMPARATIVE EXAMPLES 1 to 3 were each charged at 25° C. at 1,000 mA up to 4.2 V at a constant current, and then charged up to 50 mA at a constant voltage. Subsequently, the batteries were stored at 60° C. for 10 days. After the storage, the batteries were each discharged at 25° C. at 1,000 mA down to 2.0 V.

After the charge-discharge, each of the batteries was disassembled and the negative electrode was taken out. The amount of iron (Fe) (μg/cm²) in the negative electrode was measured by inductively coupled plasma spectrometry (ICP spectrometry). In addition, the amount of Fe (μg/cm²) in the positive electrode was measured by ICP spectrometry after the preparation of the positive electrode.

The amount of eluted iron (%) was determined from the amount of Fe in the negative electrode and the amount of Fe in the positive electrode using the formula below.

The amount of eluted Fe (%)=The amount of Fe (μg/cm²) in negative electrode/The amount of Fe (μg/cm²) in positive electrode

The amount of eluted Fe in each of the batteries of EXAMPLE 3 and COMPARATIVE EXAMPLES 1 to 3 is shown in Table 2.

TABLE 2

| | | | Amount of |
|---|---|---|---|
| | | | eluted |
| | Negative electrode | Electrolyte solution | Fe (%) |
| Example 3 | Amorphous carbon- | Vinylene carbonate 1% + | 0.009 |
| | coated natural | 0.1M Li[B(C₂O₄)₂] | |
| | graphite | | |
| Comparative | Natural graphite | Vinylene carbonate 2% | 0.003 |
| Example 1 | | | |
| Comparative | Amorphous carbon- | Vinylene carbonate 1% | 0.233 |
| Example 2 | coated natural | | |
| | graphite | | |
| Comparative | Amorphous carbon- | Vinylene carbonate 2% | 0.013 |
| Example 3 | coated natural | | |
| | graphite | | |

The amount of eluted Fe represents an amount of Fe that is eluted from the positive electrode active material and incorporated in the negative electrode. As shown in Table 2, when amorphous carbon-coated natural graphite was used as a negative electrode active material, in COMPARATIVE EXAMPLE 2, in which 1 mass percent of vinylene carbonate was used, the amount of eluted Fe was large, whereas in COMPARATIVE EXAMPLE 3, in which 2 mass percent of vinylene carbonate was used, the amount of eluted Fe was decreased. These results show that the elution of Fe from the positive electrode active material could be suppressed by using vinylene carbonate in a large amount.

In EXAMPLE 3, in which 1 mass percent of vinylene carbonate and 0.1 M of Li[B(C₂O₄)₂] were used, the amount of eluted Fe could be further reduced, as compared with COMPARATIVE EXAMPLE 3, in which 2 mass percent of vinylene carbonate was used. The reason for this is believed that, in the initial charge and discharge, Li[B(C₂₀O₄)₂], which decomposes at a potential more electropositive than that of vinylene carbonate, decomposed prior to the decomposition of vinylene carbonate, thereby forming a stable film on the surface of the negative electrode. Subsequently, vinylene carbonate decomposed, thereby forming a stable film on the surface of the positive electrode. Thus, it is believed that, during storage, the elution of Fe from the positive electrode active material to the non-aqueous electrolyte solution and deposition of the eluted Fe on the negative electrode could be suppressed.

Furthermore, referring to COMPARATIVE EXAMPLE 1, when natural graphite was used as the negative electrode active material, the amount of eluted Fe was small. The reason for this is believed to be as follows: When natural graphite is used as the negative electrode active material, the amount of decomposition of vinylene carbonate for forming a stable film on the surface of the negative electrode is small, and therefore, a stable film is formed on the surface of the positive electrode. As a result, during storage, the elution of Fe from the positive electrode active material to the non-aqueous electrolyte solution and deposition of the eluted Fe on the negative electrode can be suppressed.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A lithium secondary battery comprising:
a positive electrode containing a lithium transition-metal oxyanion compound as a positive electrode active material;
a negative electrode containing amorphous carbon-coated graphite as a negative electrode active material; and
a non-aqueous electrolyte solution,
wherein the non-aqueous electrolyte solution contains vinylene carbonate and a solvent and/or a solute that decomposes at a potential more electropositive than that of vinylene carbonate.

2. The lithium secondary battery according to claim 1, wherein the lithium transition-metal oxyanion compound is LiFePO₄.

3. The lithium secondary battery according to claim 1, wherein the solvent and/or solute that decomposes at a potential more electropositive than that of vinylene carbonate is a solvent selected from the group consisting of fluoroethylene carbonate and vinyl ethylene carbonate.

4. The lithium secondary battery according to claim 2, wherein the solvent and/or solute that decomposes at a potential more electropositive than that of vinylene carbonate is a solvent selected from the group consisting of fluoroethylene carbonate and vinyl ethylene carbonate.

5. The lithium secondary battery according to claim 1, wherein the solvent and/or solute that decomposes at a potential more electropositive than that of vinylene carbonate is Li[B(C₂O₄)₂].

6. The lithium secondary battery according to claim 2, wherein the solvent and/or solute that decomposes at a potential more electropositive than that of vinylene carbonate is Li[B(C₂O₄)₂].

7. The lithium secondary battery according to claim 3, wherein the solvent and/or solute that decomposes at a potential more electropositive than that of vinylene carbonate is fluoroethylene carbonate.

8. The lithium secondary battery according to claim 4, wherein the solvent and/or solute that decomposes at a potential more electropositive than that of vinylene carbonate is fluoroethylene carbonate.

9. The lithium secondary battery according to claim 1, wherein the solvent and/or solute that decomposes at a potential more electropositive than that of vinylene carbonate is a solvent that has an isocyanate group.

10. The lithium secondary battery according to claim 2, wherein the solvent and/or solute that decomposes at a potential more electropositive than that of vinylene carbonate is a solvent that has an isocyanate group.

11. The lithium secondary battery according to claim 9, wherein the solvent that decomposes at a potential more electropositive than that of vinylene carbonate is a linear isocyanate compound.

12. The lithium secondary battery according to claim 10, wherein the solvent that decomposes at a potential more electropositive than that of vinylene carbonate is a linear isocyanate compound.

13. The lithium secondary battery according to claim 11, wherein the linear isocyanate compound is 1,6-diisocyanate hexane.

14. The lithium secondary battery according to claim 12, wherein the linear isocyanate compound is 1,6-diisocyanate hexane.
